(19) United States
(12) Patent Application Publication
(10) Pub. No.: US 2020/0287439 A1
(43) Pub. Date: Sep. 10, 2020

(54) BRUSHLESS MOTOR AND ELECTRONIC PRODUCTS HAVING THE BRUSHLESS MOTOR

(71) Applicant: NIDEC CORPORATION, Kyoto (JP)

(72) Inventors: Tiecheng ZHANG, Kyoto (JP); Zhenmin HAN, Kyoto (JP); Tingting ZHENG, Kyoto (JP)

(73) Assignee: NIDEC CORPORATION, Kyoto (JP)

(21) Appl. No.: 16/790,704

(22) Filed: Feb. 13, 2020

(30) Foreign Application Priority Data
Mar. 5, 2019 (CN) 201910164330.7

(51) Int. Cl. H02K 5/16; H02K 5/124

(52) U.S. Cl. CPC H02K 5/163; H02K 5/124

(57) ABSTRACT

A brushless motor and an electronic product having the brushless motor are provided. The brushless motor includes: a shaft, a stator part disposed on the periphery of the shaft, a rotor part disposed on the periphery of the stator part, a bearing part, and a housing. The housing includes: an upper plate part located on an axial side of the rotor part, a tubular part extending in an axial direction from a radial outer side of the upper plate part, and a lower plate part located on the other axial side of the rotor part. An accommodating part is formed around the shaft on a radial inner side of the upper plate part, and a sealing component is arranged between the accommodating part and the shaft.

The present invention claims priority under 35 U.S.C. § 119 to Chinese Application No. 201910164330.7 filed on Mar. 5, 2019 the entire content of which is incorporated herein by reference.

### BACKGROUND

### Technical Field

The disclosure relates to the electromechanical field, and in particular, to a brushless motor and an electronic product having the brushless motor.

### Description of Related Art

When a motor is used, it is generally required that a housing of the motor reaches a certain ingress protection rating, to prevent external miscellanies and water vapor from entering the motor to cause damage to internal components of the motor.

For an inner rotor motor, because a stator is disposed outside a rotor, the stator is stationary relative to a housing of the motor. Therefore, when manufactured, the housing of the inner rotor motor easily reaches a predetermined ingress protection rating. However, for an outer rotor motor, because a rotor is disposed outside a stator, the rotor rotates at a high speed relative to a housing of the motor. Therefore, when manufactured, it is not easy for the housing of the outer rotor motor to reach a predetermined ingress protection rating.

An outer rotor motor which has seal ring disposed in a gap between a cover body and a rotary shaft, to prevent external miscellanies and water vapor from entering the motor, is known.

It is found that, due to a small contact area between the sealing ring and an outer cover, the sealing ring is not easily fastened to the outer cover. When the rotary shaft rotates at a high speed, the sealing ring may easily fall off from the gap. Consequently, the motor is not sealed, and the service life of the motor is shortened. In addition, the sealing ring is in surface contact with the rotary shaft. Consequently, the friction between the sealing ring and the rotary shaft increases, and the sealing ring is easily worn, leading to a short service life.

It should be noted that the introduction in Background is merely provided for the convenience of clearly and comprehensively describing the technical solutions of the disclosure and facilitating the understanding of those skilled in the art. These technical solutions shall not be deemed well-known by those skilled in the art simply for having been described in Background.

### SUMMARY

According to a first aspect of the embodiments of the disclosure, a brushless motor is provided. The brushless motor includes: a shaft, extending along a central axis; a stator part, disposed on a periphery of the shaft; a rotor part, disposed on a periphery of the stator part, arranged facing the stator part in a radial direction, and fastened to the shaft to rotate as the shaft rotates; a bearing part, disposed on a periphery of the shaft, and supporting the shaft in rotation; and a housing, receiving the stator part, the rotor part, and the bearing part, and including: an upper plate part located on an axial side of the rotor part, a tubular part extending in an axial direction from a radial outer side of the upper plate part, and a lower plate part located on an other axial side of the rotor part. An accommodating part is formed around the shaft on a radial inner side of the upper plate part, and a sealing component is arranged between the accommodating part and the shaft.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram of a brushless motor according to Embodiment 1 of the disclosure.

FIG. 2 is a schematic diagram of a sealing component viewed from an angle according to the disclosure.

FIG. 3 is a schematic diagram of the sealing component viewed from another angle according to the disclosure.

FIG. 4 is a schematic diagram of a cross section viewed in a B-B direction in FIG. 3.

FIG. 5(a) to FIG. 5(c) are other schematic diagrams of the brushless motor according to Embodiment 1 of the disclosure.

### DESCRIPTION OF THE EMBODIMENTS

The foregoing and other features of the disclosure will become apparent from the following specification with reference to the accompanying drawings. Specific embodiments of the disclosure are disclosed in the specification and the accompanying drawings. The specification and the accompanying drawings describe several embodiments to which the principles of the disclosure are applicable. However, it should be understood that, the disclosure is not limited to the embodiments described herein, but shall include all modifications, variations and equivalents falling within the scope of the appended claims.

In the embodiments of the disclosure, terms such as “first”, “second”, “upper”, and “lower” are used for distinguishing different elements in name, but it does not indicate spatial arrangement or time sequence of these elements, and these elements should not be limited by these terms. The term “and/or” includes any one or all combinations of the one or more associated listed terms. Terms such as “contain”, “include”, and “comprise” refer to existence of the stated features, elements, parts, or components, but does not exclude existence or adding of one or more other features, elements, parts, or components.

In the embodiments of the disclosure, a singular form such as “a” or “an” includes a plural form. The singular form should be broadly understood as “a type” or “a class”, and rather than limited to the meaning “one”. In addition, the term “the” should be understood as including both a singular form and a plural form, unless otherwise specified in the context. In addition, the terms “according to” should be understood as “according to at least . . . ”, and the term “based on” should be understood as “based on at least . . . ”, unless otherwise specified in the context.

In addition, in the following description of the disclosure, for ease of description, a radius direction centered on a central axis of a shaft of a motor is referred to as a “radial direction”, a direction around the central axis is referred to as a “peripheral direction”, a direction along the central axis is referred to as an “axial direction” or an “extending direction of the axial direction”, a side away from the central axis in the radius direction is referred to as a “radial outer side”, and a side close to the central axis in the radius direction is referred to as a “radial inner side”.

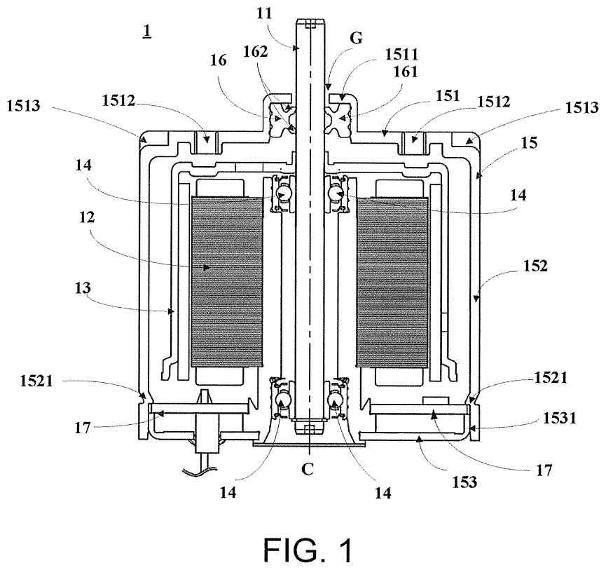

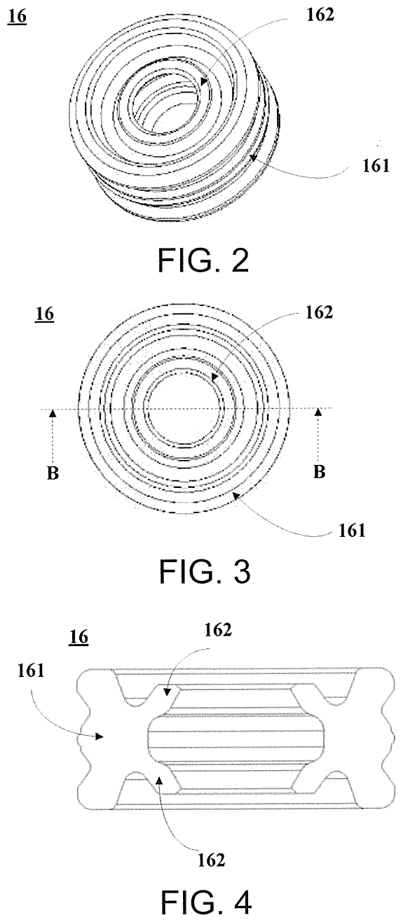

Embodiment 1 of the disclosure provides a brushless motor. FIG. 1 is a schematic diagram of the brushless motor according to Embodiment 1 of the disclosure. FIG. 2 is a schematic diagram of a sealing component viewed from an angle according to the disclosure. FIG. 3 is a schematic diagram of the sealing component viewed from another angle according to the disclosure. FIG. 4 is a schematic diagram of a cross section viewed in a B-B direction in FIG. 3.

In the present embodiment, as shown in FIG. 1, a brushless motor 1 includes: a shaft 11, a stator part 12, a rotor part 13, a bearing part 14, and a housing 15. The shaft 11 extends along a central axis C. The stator part 12 is disposed on the periphery of the shaft 11. The rotor part 13 is disposed on the periphery of the stator part 12, arranged facing the stator part 12 in a radial direction, and fastened to the shaft 11 to rotate as the shaft 11 rotates. The bearing part 14 is disposed on the periphery of the shaft 11, and supports the shaft 11 in rotation. The housing 15 receives the stator part 12, the rotor part 13, and the bearing part 14.

In the present embodiment, as shown in FIG. 1, the housing 15 includes: an upper plate part 151 located on an axial side of the rotor part 13, a tubular part 152 extending in an axial direction from a radial outer side of the upper plate part 151, and a lower plate part 153 located on the other axial side of the rotor part 13. An accommodating part 1511 is formed around the shaft 11 on a radial inner side of the upper plate part 151, and a sealing component 16 is arranged between the accommodating part 1511 and the shaft 11. Therefore, the sealing component 16 is received in the accommodating part 1511, which can prevent the sealing component 16 from falling off when the shaft 11 rotates at a high speed, thereby ensuring that the motor is sealed well, improving dust-proof and water-proof performance of the motor, and prolonging the service life of the motor.

In the present embodiment, as shown in FIG. 1, the accommodating part 1511 is a structure protruding along a direction away from the stator part 12 in the axial direction, but the disclosure is not limited thereto. The accommodating part 1511 may alternatively be a structure recessed along a direction close to the stator part 12 in the axial direction. As long as the sealing component 16 can be received, this is not limited in the disclosure.

In an implementation of the present embodiment, as shown in FIG. 2 to FIG. 4, the sealing component 16 includes a body part 161 and at least two contact parts 162, and the contact parts 162 extend from the body part 161 to a radial inner side. As shown in FIG. 1, the contact parts 162 are in contact with the shaft 11, so that the shaft 11 is tightly clamped by using the contact parts 162. Because the sealing component 16 is in contact with the shaft 11 by using only the contact parts 162, a contact area between the sealing component 16 and the shaft 11 is small, so that the friction between the sealing component 16 and the shaft 11 is reduced, and the sealing component 16 is worn less. In addition, a lubricating oil may further be applied between the contact parts 162 and the shaft 11, to improve the lubrication, and reduce the friction between the contact parts 162 and the shaft 11. Therefore, the sealing component 16 is worn less, and the service life of the sealing component 16 is prolonged.

In the present embodiment, as shown in FIG. 4, a cross section of the contact parts 162 is in a claw shape, but the present embodiment is not limited thereto. The cross section of the contact parts 162 may alternatively be in other shapes, for example, a parallelogram or a rectangle, as long as the shaft 11 can be clamped. In addition, in the present embodiment, two contact parts 162 are taken as an example for description, but this is not limited in the present embodiment. There may alternatively be three or more contact parts 162. In addition, extension lines of the two contact parts 162 in the present embodiment intersect in a direction extending to the body part 161. An intersection angle is not limited in the present embodiment, which may be any angle between 0° and 180°. Alternatively, extension lines of a plurality of contact parts 162 may be parallel in the direction extending to the body part 161.

In the present embodiment, the sealing component 16 is formed of an elastic material. The elastic material is, for example, rubber, an elastic nylon material, or silica gel, which is not limited in the present embodiment. The elastic material may further have specific hardness, to ensure wear resistance. The hardness ranges, for example, from 65 HA to 75 HA, and may alternatively be within other ranges, which is not limited in the present embodiment.

In the present embodiment, as shown in FIG. 1, the accommodating part 1511 and the shaft 11 are arranged with a gap G. Therefore, rigid contact between the housing 15 and the shaft 11 can be avoided, and a mechanical loss of the motor due to the friction between the housing 15 and the shaft 11 can also be avoided. In addition, a portion of the accommodating part 1511 nearest to the stator part 12 in the axial direction is closer to the stator part 12 than a portion of the sealing component 16 nearest to the stator part 12 in the axial direction. Therefore, the sealing component 16 is totally received in the accommodating part 1511, and can be fastened reliably and hardly fall off, thereby ensuring that the motor is sealed well.

In the present embodiment, the accommodating part 1511, the upper plate part 151, and the tubular part 152 are integrally formed. Therefore, the housing can be formed through a simple process, thereby reducing manufacturing costs. In addition, the housing 15 is formed of a high-strength material, for example, steel. A strength range of the high-strength material is, for example, equal to or greater than 10 kgf/mm². Therefore, crushing resistance of the housing 15 is ensured.

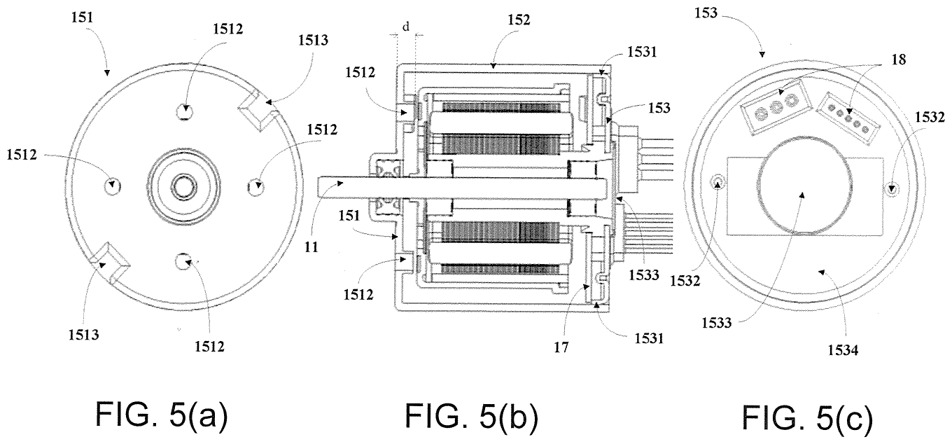

FIG. 5(a) to FIG. 5(c) are other schematic diagrams of the brushless motor according to Embodiment 1 of the disclosure. FIG. 5(a) shows a status of the brushless motor viewed from an axial side of the brushless motor, FIG. 5(c) shows a status of the brushless motor viewed from the other side of the brushless motor, and FIG. 5(b) shows a status of the brushless motor viewed in the radial direction of the brushless motor. FIG. 5(a) and FIG. 5(c) are schematic diagrams, and FIG. 5(b) is a cross-sectional view.

In the present embodiment, as shown in FIG. 5(a), the upper plate part 151 is provided with a plurality of through holes 1512. A quantity of the through holes 1512 is four herein, and may alternatively be other quantities such as two or five, which is not limited in the disclosure. The plurality of through holes 1512 are formed by performing a stamping process on the upper plate part 151. As shown in FIG. 5(b), a portion, provided with the plurality of through holes 1512, of the upper plate part 151 is recessed by a predetermined depth d along a direction close to the stator part 12 in the axial direction, and an inner wall of the through hole 1512 is provided with a thread. Therefore, an effective contact length of the through hole 1512 and a screw is increased by using the stamping process, and the upper plate part 151 is clamped more tightly.

In the present embodiment, as shown in FIG. 1, the tubular part 152 is provided with a positioning part 1521 recessed to a radial inner side. That is, a portion of the tubular part 152 is recessed to the radial inner side to form the positioning part 1521. An axial side of the stator part 12 close to the lower plate part 153 is provided with a circuit board 17. The positioning part 1521 is in contact with the circuit board 17, to position the circuit board 17.

In addition, the positioning part 1521 may not be disposed on the axial side of the tubular part 152 close to the lower plate part 153 as shown in FIG. 1. A location of the positioning part 1521 may be adjusted depending on a location of the circuit board 17. For example, the circuit board 17 may be disposed on an axial side of the stator part 12 close to the upper plate part 151. The positioning part 1521 may be disposed on an axial side of the tubular part 152 close to the upper plate part 151 and corresponding to the circuit board 17, to position the circuit board 17.

In the present embodiment, as shown in FIG. 1, the lower plate part 153 includes a folded part 1531 extending along a direction close to the stator part 12 in the axial direction on a radial outer side. A radial outer surface of the folded part 1531 is fastened to a radial inner surface of the tubular part 152. Therefore, the sealing performance between the lower plate part 153 and the tubular part 152 is ensured. In addition, the circuit board 17 may further be in contact with the folded part 1531. Therefore, the circuit board 17 is fastened by using both the positioning part 1521 and the folded part 1531, to further ensure the stability of the circuit board 17.

In the present embodiment, as shown in FIG. 5(a) and FIG. 5(c), one side of the upper plate part 151 away from the stator part 12 is provided with a protection jig positioning part 1513, one side of the lower plate part 153 away from the stator part 12 is provided with a positioning blind hole 1532, and the upper plate part 151 and the lower plate part 153 are positioned and assembled by using the protection jig positioning part 1513 and the positioning blind hole 1532.

In addition, in the present embodiment, as shown in FIG. 5(c), the side of the lower plate part 153 away from the stator part 12 is provided with a wire connector 18. Two wire connectors 18 are shown in FIG. 5(c), but the present embodiment is not limited thereto. The quantity of the wire connectors may be one, three, or the like. The periphery of the wire connector 18 may further be provided with a sealing member such as a sealant (not shown in the figure). In addition, a central portion 1533 of the lower plate part 153 protrudes relative to a peripheral portion 1534 around the central portion 1533 in a direction away from the stator part 12, and an edge of the central portion 1533 may also be provided with a sealing member (not shown in the figure). Therefore, the periphery of the housing is sealed by various sealing members, which improves dust-proof and water-proof effects of the motor, and improves an ingress protection rating of the motor. For example, the ingress protection rating of the motor is equal to or higher than IP51.

According to the embodiment of the disclosure, the sealing component is received in the accommodating part, which can prevent the sealing component from falling off when the shaft rotates at a high speed, thereby ensuring that the motor is sealed well, improving dust-proof and water-proof performance of the motor, and prolonging the service life of the motor.

Embodiment 2 of the disclosure provides an electronic product, which includes the brushless motor in Embodiment 1. As the structure of the brushless motor is described in detail in Embodiment 1, content thereof is incorporated herein and not described herein.

In the present embodiment, a structure of the electronic product is not limited, which may be household appliances such as an air conditioner, a water dispenser, a washing machine, a sweeper, a compressor, a blower, and a mixer, or may be electronic products in other fields.

According to the present embodiment, the sealing component is received in the accommodating part, which can prevent the sealing component from falling off when the shaft rotates at a high speed, thereby ensuring that the motor is sealed well, improving dust-proof and water-proof performance of the motor, prolonging the service life of the motor, and prolonging the service life of the electronic product.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A brushless motor, comprising:
a shaft, extending along a central axis;
a stator part, disposed on a periphery of the shaft;
a rotor part, disposed on a periphery of the stator part, arranged facing the stator part in a radial direction, and fastened to the shaft to rotate as the shaft rotates;
a bearing part, disposed on the periphery of the shaft, and supporting the shaft in rotation; and
a housing, receiving the stator part, the rotor part, and the bearing part, and comprising: an upper plate part located on an axial side of the rotor part, a tubular part extending in an axial direction from a radial outer side of the upper plate part, and a lower plate part located on an other axial side of the rotor part,
wherein an accommodating part is formed around the shaft on a radial inner side of the upper plate part, and a sealing component is arranged between the accommodating part and the shaft.

2. The brushless motor according to claim 1, wherein the sealing component comprises:
a body part; and
at least two contact parts that extend from the body part to a radial inner side, and are in contact with the shaft.

3. The brushless motor according to claim 1, wherein the sealing component is formed of an elastic material.

4. The brushless motor according to claim 1, wherein the accommodating part and the shaft are arranged with a gap.

5. The brushless motor according to claim 1, wherein a portion of the sealing component nearest to the stator part in the axial direction is further away from the stator part than a portion of the accommodating part nearest to the stator part in the axial direction.

6. The brushless motor according to claim 1, wherein the upper plate part is provided with a plurality of through holes, and a portion, provided with the plurality of through holes, of the upper plate part is recessed along a direction close to the stator part in the axial direction.

7. The brushless motor according to claim 1, wherein the accommodating part, the upper plate part, and the tubular part are integrally formed.

8. The brushless motor according to claim 1, wherein the housing is formed of a high-strength material, and a strength range of the high-strength material is equal to or greater than 10 kgf/mm².

9. The brushless motor according to claim 1, wherein the lower plate part comprises a folded part extending along a direction close to the stator part in the axial direction on a radial outer side, and
a radial outer surface of the folded part is fastened to a radial inner surface of the tubular part.

10. The brushless motor according to claim 1, wherein an axial side of the stator part close to the lower plate part is provided with a circuit board,
the tubular part is provided with a positioning part recessed to a radial inner side, and
the circuit board is in contact with the positioning part.

11. The brushless motor according to claim 10, wherein the lower plate part comprises a folded part extending along a direction close to the stator part in the axial direction on a radial outer side, and
the circuit board is in contact with the folded part.

12. The brushless motor according to claim 1, wherein a side of the upper plate part away from the stator part is provided with a protection jig positioning part, a side of the lower plate part away from the stator part is provided with a positioning blind hole.

13. The brushless motor according to claim 1, wherein a side of the lower plate part away from the stator part is provided with a wire connector, and a periphery of the wire connector is provided with a sealant.

14. The brushless motor according to claim 1, wherein a central portion of the lower plate part protrudes relative to a peripheral portion around the central portion in a direction away from the stator part, and an edge of the central portion is provided with a sealing member.

15. An electronic product, comprising the brushless motor according to claim 1.
